(19) United States
(12) Patent Application Publication
(10) Pub. No.: US 2019/0190966 A1
(43) Pub. Date: Jun. 20, 2019

(54) Client Device Based User Friendly Interface Wizards for Gathering, Editing and Packaging Media Content and Metadata for Uploading to a Content Management System

(71) Applicant: GOOGLE INC., Mountain View, CA (US)

(72) Inventors: Xavier François Décoret, Zurich (CH); Mathieu Robin, Zurich (CH); Alin Sinpalean, Zurich (CH); Gareth McSorley, Adliswil (CH)

(73) Assignee: GOOGLE INC., Mountain View, CA (US)

(21) Appl. No.: 13/836,643

(22) Filed: Mar. 15, 2013

Related U.S. Application Data
(60) Provisional application No. 61/653,976, filed on May 31, 2012.

(51) Int. Cl. H04L 29/06

(52) U.S. Cl. CPC H04L 65/40

(57) ABSTRACT

Client computer based user interface (UI) wizards for ingesting media content and associated metadata into a remote content management system (CMS) are disclosed. One or more UI wizards gather the media content and metadata by using user friendly interfaces that prompt a user for information. The UI wizards are representation agnostic. The UI wizard(s) bundle the media content and metadata and initiates upload of the bundle to a server computer in an automatically persistent manner.

### CROSS-REFERENCE TO RELATED APPLICATIONS

This application claims the benefit of U.S. Provisional Application No. 61/653,976, filed May 31, 2012 and entitled CLIENT DEVICE BASED USER FRIENDLY INTERFACE WIZARDS FOR GATHERING, EDITING AND PACKAGING MEDIA CONTENT AND METADATA FOR UPLOADING TO A CONTENT MANAGEMENT SYSTEM, the entirety of which is incorporated herein by reference.

### TECHNICAL FIELD

The subject disclosure relates to computer networking, and specifically to client device based user friendly interface wizards for uploading media content and related metadata to a content management system (CMS).

### BACKGROUND

Advances in computing technology and the Internet have changed the manner in which media content is created and distributed. The widespread availability and use of the Internet allows individual artists (or small groups of artists) to also become distributors of their respective works to a global audience, instead of having to rely on large entertainment or publishing houses for the distribution. For example, it has now become commonplace for artists around the world to create short films or movies by using handheld video cameras, edit them by using personal computers, and upload them to video hosting websites or video libraries by using the Internet. However, while distribution of media content has become easier, commercialization of the media content still requires the distributor to consider many complex factors including, for example, the desired monetization policies and social norms in the various geographical locations in which the content creator (or distributor) desires to monetize his/her content.

It would be desirable to have a user friendly and user interactive computer system that allows creative works creators around the world to distribute and monetize their creative works to a global audience without requiring them to become or hire sophisticated technologists.

### SUMMARY

The following presents a simplified summary of some embodiments of the subject disclosure in order to provide a basic understanding of some aspects of such embodiments. This summary is not an extensive overview of the specification. It is intended to neither identify key elements of the specification nor delineate the scope of any particular embodiments of the specification, or any scope of the claims. Its sole purpose is to present some concepts of the specification in a simplified form as a prelude to the more detailed description that is presented in this disclosure.

In an implementation of the subject disclosure, a client computer includes a first UI wizard component that interactively gathers media content and metadata from a user, a second UI wizard component that bundles (or packages) the media content and metadata, and a third UI wizard component that uploads the bundle to a server computer by way of a network link. The UI wizard components are hosted by the client computer, are user friendly and include graphical interfaces that prompt a user of the client computer for media content or metadata information. In an example, the client and server computers communicate by using Hypertext Transfer Protocol Secure (HTTPS). The bundle is uploaded in resumable and automatically persistent manners. The UI wizard components and the bundle are compatible with one or more tool chains of the server computer. Moreover, the UI wizard components are representation agnostic to the user of the client computer, meaning that in this disclosure, the user of the client computer is not requested or required to modify any source code of the UI wizard components.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates a block diagram of an exemplary client computer, according to an implementation of the subject disclosure.

FIG. 2 illustrates a block diagram of an exemplary server computer, according to an implementation of the subject disclosure.

FIGS. 3A, 3B, 4, 5A, 5B, 5C, 6A, 6B, 7A, 7B, 7C, 7D, 8 and 9 illustrate exemplary graphical representations of various user interface (UI) wizards, according to implementations of the subject disclosure.

FIG. 10 illustrates a flow diagram of an exemplary method for preparing and uploading a bundle of media content and metadata by using UI wizards, according to an aspect of the subject disclosure.

FIG. 11 illustrates a schematic block diagram of an exemplary computing environment in which the client and server computers of the subject disclosure can be implemented.

FIG. 12 illustrates a schematic diagram of an exemplary networked or distributed computing environment in which the client and server computers of the subject disclosure can be implemented.

### DETAILED DESCRIPTION

The subject disclosure is now described with reference to the above drawings, wherein like reference numerals are used to refer to like elements throughout. In the following description, for purposes of explanation, numerous specific details are set forth in order to provide a thorough understanding of the subject disclosure. It may be evident, however, that the subject disclosure can be practiced without these specific details. In other instances, well-known structures and devices are shown in block diagram form in order to facilitate describing the subject disclosure.

It is to be appreciated that in accordance with one or more aspects described in this disclosure, users can opt-out of providing personal information, demographic information, location information, proprietary information, sensitive information, or the like in connection with data gathering aspects. Moreover, one or more aspects described herein can provide for anonymizing collected, received, or transmitted data.

In an implementation of the subject disclosure, a set of client device based (e.g., client computer) user interface (UI) wizard components gather media content and metadata from a client device's user by requesting simple user interactions, bundling the content and metadata and uploading the bundle to a remote server. In the subject disclosure, the terms UI wizards, a set of UI wizards, UI wizard components and representations of UI wizards are used interchangeably. Regarding media content, a user of the client device can drag and drop the media content file(s) into a wizard box or browse and select the media content file(s) from the client device's memory. Regarding metadata, the UI wizards include a graphical interface for interviewing the user of the client device, such that a user's profile may be populated via interactive questioning of the user.

According to an aspect of the subject disclosure, the metadata includes identification information about associated content creator(s) and subject matter of the media content (e.g. genre and title of the media content), as well as the user's instructions (or policies or objectives or rules) for distribution and/or monetization of the media content. For example, metadata can include a user's request to receive periodic feedback about the number of times users have selected his/her media content and the number of downloads or views of his/her media content, or similar information categorized by geographical regions. The metadata can also include fingerprinting information for the media content and a request to block any unauthorized uploads or copying of the media content by others. According to an aspect of the subject disclosure, the UI wizards include drop down menus that allow the user of the client computer to select region(s) of the world in which the user has rights in the media content and/or where the user wishes to distribute and/or monetize the media content. A region in the menu can be custom created by the user to include, for example, one or more countries, one or more states, one or more cities, etc., or a combination thereof.

Once completed, a representation of the user's profile/metadata can be saved (or stored) in the client device's memory and/or stored in a cloud storage device for retrieval by a client device, for use as a batch uploading and/or in future media content uploads. In an implementation, the UI wizards initially populate (or pre-fill) the metadata fields with a previously used representation of the user's profile/metadata and prompt the user to make any edits to the populated fields. In an implementation, the UI wizards additionally or alternatively pre-populate (or pre-fill) the metadata fields using data from other sources, e.g., ID3 tags from media files selected for upload. The UI wizards can also interact with a system memory (or network or cloud memory) of the client device to completely or partially populate the user profile/metadata fields. In an implementation, the UI wizards can alert the user if a file selected for uploading does not correspond to a chosen metadata wizard. For example, if the user selects a UI wizard associated with video uploads and then selects a file for upload that is an audio file rather than a video file, the UI wizard can alert the user that the audio file does not correspond to file types associated with the current wizard and ask that the user select another file.

According to an aspect of the subject disclosure, the UI wizards upload representations of the media content and metadata to a network server. The network server can include a music hosting site, video hosting site, a social networking site or a business networking site, of which the user of the client computer is a partner or a subscriber. According to an aspect of the subject disclosure, the uploading is performed in a resumable manner, meaning that any uploaded data is automatically and persistently saved by the network server. Thus, if the uploading process is interrupted, for example, because of loss of network connection or electricity, or intentionally interrupted because the user desires to use the client computer for different purpose(s) or to temporarily shut it down, the uploading process need not be restarted from the beginning but instead can resume from the point of interruption. According to an aspect of the subject disclosure, the network server processes the bundle immediately in real time (e.g. fingerprinting and/or transcoding a video in real time) as the bundle data is being uploaded. In other words, the network server does not wait for the upload of the entire bundle to be completed prior to commencing the processing of the bundle. According to an aspect of the subject disclosure, the implementation of the user's instructions (or policies) commences immediately upon the initiation of the upload, e.g., well in advance of the completion of the uploading. Thus, for example, if a user desires to prevent his/her video from being viewed in a particular geographical location, that policy is implemented even as the video is being uploaded. This feature can be particularly beneficial during live uploads (or viewings) of events, for example live music concerts or sporting events.

According to an aspect of the subject disclosure, the UI wizards are representation agnostic, meaning that in this disclosure, the programming of the UI wizards is decoupled from the user friendly interface representation of the UI wizards to the user of the client computer. In other words, no programming of the instructions for the operation of the UI wizards in required by the end user. For example, a video hosting website provider that creates the UI wizards can create a new version of the UI wizards that does not affect the representation of the interactive interface that is presented to the end user. In this example, the video hosting site can send the new version of the UI wizards to the user of the client device for installation on the client device by way of a mobile memory device (e.g. compact disk), or, if authorized by the user of the client device, the new version can be downloaded to the client device by way of a network connection. The user of the client device need not have knowledge of background instructional (or programming) changes that were made in the new version to be able to use the new UI wizards, and need not know how to make those changes, thereby making the UI wizards representation agnostic. According to an aspect of the subject disclosure, the UI wizards can be tailored for individual users or groups of users, for example, by masking certain portions or inquiries that are not relevant to particular users. According to an aspect of the subject disclosure, only particular portions of the UI wizards are presented to the user of the client device based on the nature or subject matter of the media content to be uploaded. For example, if the user desires to upload a video, the UI wizards related to music are masked such that metadata inquiries about music are not presented to the user.

In one implementation of the subject disclosure, the client device communicates with the server computer by using Hypertext Transfer Protocol Secure (HTTPS). The set of UI wizards includes one or more application programs that are resident on the client device. The programs provide an interactive graphical interface, which can include drop boxes, pushbutton icons, drag and drop features, etc.. The UI wizards communicate with the server by using an application program interface (API) layer that runs on top of the HTTPS layer. In addition to gathering information by interacting with a user, the UI wizards can also be configured to access information from other sources such as the media files selected for uploading. For example, ID3 tags and International Standard Recording Codes (ISRC) of the media file can be read and used to pre-populate fields of the wizard. By operating locally on the user device, the UI wizards enhance their speed of the interaction with information stored on the user device while generating metadata. Moreover, by operating locally on the user device, the UI wizards can gather and bundle media content and metadata without requiring an active (or enabled) network connection to do so. In other implementations, the client device communicates with the server computer by using HTTP or other suitable protocols, depending on the application.

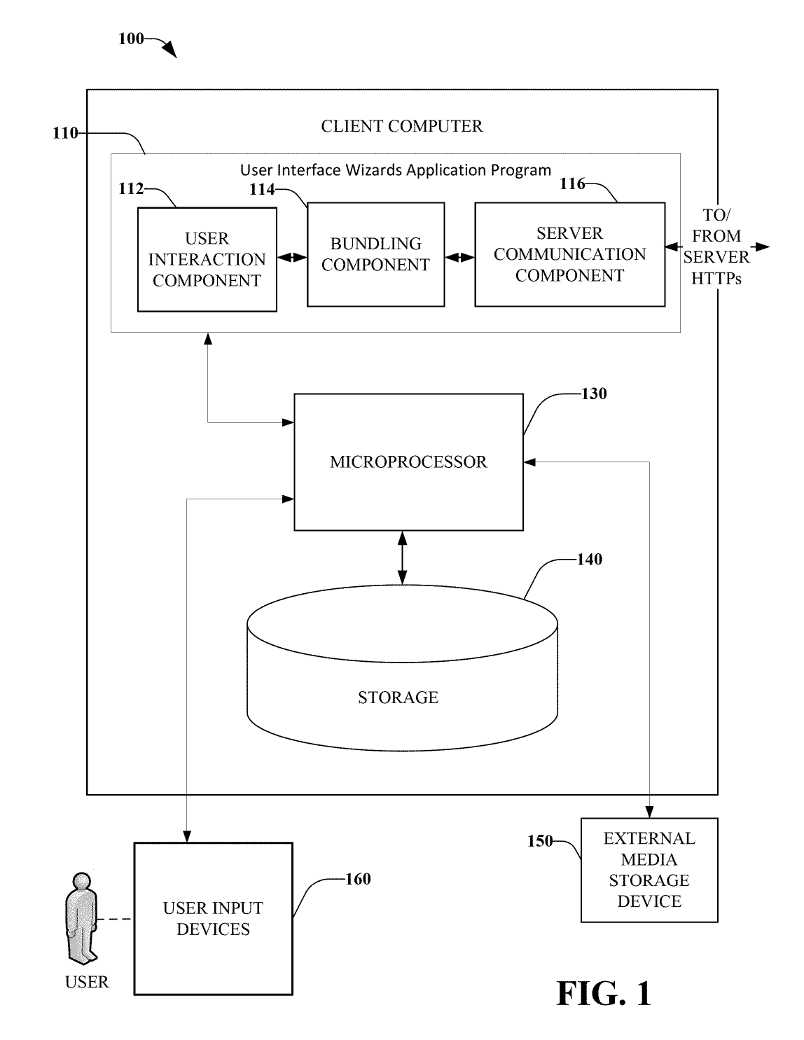

FIG. 1 illustrates a block diagram of an exemplary client device, client computer 100, configured to prepare media content and metadata for ingestion into a remote content management system (CMS), according to an aspect of the subject disclosure. The client computer 100 includes an application program (and plug-in(s)) 110 including computer executable user interface (UI) wizard components 112, 114 and 116, a microprocessor 130 and a storage device 140. The microprocessor 130 is coupled to the storage device 140, and can be coupled to an external media storage device 150 and one or more user input devices 160 (e.g., keyboard, disk drive, video camera, a mouse and/or a microphone for a voice recognition system). The application program 110 includes computer executable components 112, 114 and 116 that can be stored in the storage 140 or the external media storage device 150, or both. Storage devices 140 and 150 can include non-transitory memory devices, e.g., memory devices that are used for long term persistent storage. Examples of non-transitory memory devices include random access memory, hard disks and flash memory devices.

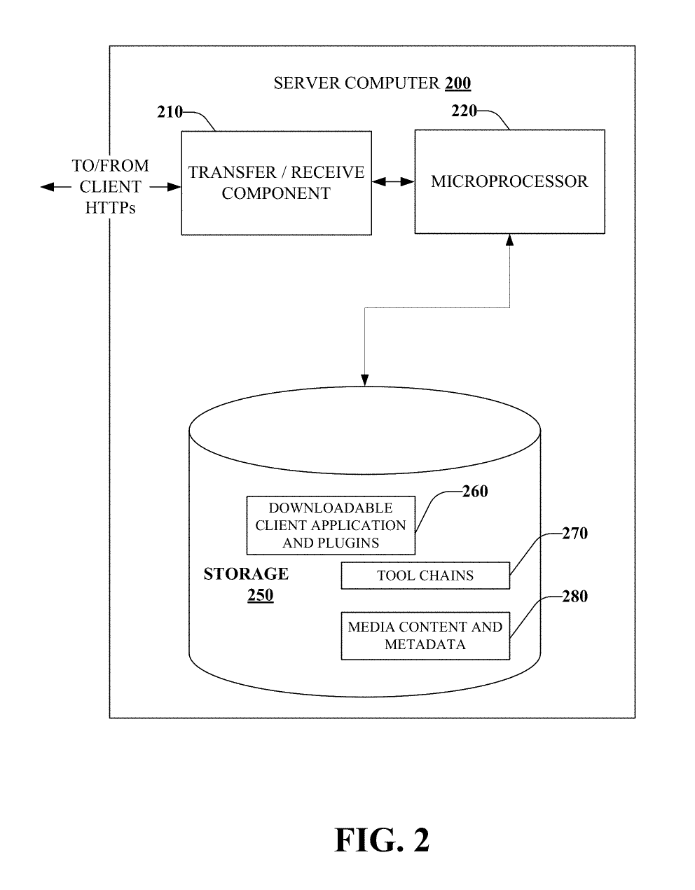

In one implementation of the subject disclosure, the application program and associated plug-in(s) 110 are created by the owner, manager or service provider of a network server, for example, a network server that hosts videos (e.g. server computer 200 shown in FIG. 2). In one implementation of the subject disclosure, the representations of the application program (and associated plug-in(s) 110 are generated or tailored by one or more third party providers. In that implementation, third parties customize the components 112, 114 and 116 according to a user's experiences and preferences for installation on the client computer in the form of plug-in(s) program(s). The ‘UI wizards’ application program 110 can be downloaded from the server computer 200 to the client computer 100. According to an aspect of the subject disclosure, the user interaction component 112 requests information from a user of the client computer 100 by way of a user friendly graphical interface (e.g. 300, 400, 500, 600 and 700). The user can interact with the graphical interface by using the user input devices 160. User interaction component 112 can also gather user profile and metadata information from other sources including, for example, ID3 tags, cloud memory and storage device 140 or 150, either automatically upon initiation of the application program 110 or in response to user command(s).

The bundling component 114 packages (or bundles) the media content and metadata. In an implementation, the packaging includes formatting the media content and bundle in a manner that is compatible with tool chains of the server computer 200. In an implementation, packaging additionally includes encryption and/or encoding of the media content and metadata. The server communication component 116 communicates with the server computer 200 by using, for example, the Hypertext Transfer Protocol Secure (HTTPS) protocol. The server communication component 116 communicates with the server computer 200 either directly or by way of the microprocessor 130. According to an aspect of the subject disclosure, the server communication component 116 monitors the network connection during the upload and provides user selectable tools, such as soft-button tools, for pausing, restarting and canceling the upload. In one implementation, the server communication component 116 automatically commences the uploading of a bundle upon completion of the bundling process by the bundling component 114. In one implementation, the user must provide his/her authentication information (e.g. username and password) as a pre-condition for the uploading to commence. In one implementation, a UI wizard 112 automatically prompts a user to enter his/her authentication information upon completion of the bundling process by the bundling component 114. Moreover, in one implementation, upon completion of the uploading, the server communication component 116 provides a user selectable link to the CMS location where the uploaded media content is stored. In an example, upon selecting the link, the user must enter his/her authentication information (e.g. username and password) to access the uploaded media content. In an example, upon accessing the media content in the CMS, the user can make further edits to the media content or metadata.

FIG. 2 illustrates a block diagram of an exemplary server computer 200 that represents a content management system (CMS) or a part thereof, according to an aspect of the subject disclosure. The server computer 200 includes a microprocessor 220 coupled to a transfer/receive component 210 and a storage device 250. The storage device 250 includes downloadable client application and plugins 260 related to the UI wizards. The storage device 250 also includes tool chains 270 for the server computer 200. The downloadable client applications and plugins 260 are compatible with the tool chains 270. A tool chain is the set of development programming tools that are used to create a software product. The development tools of the tool chain format can be used in a chain, such that the output of a tool becomes the input for the next tool. A simple software development tool chain can consist of a text editor for editing source code, a compiler and linker to transform the source code into an executable program, libraries to provide interfaces to the operating system, and a debugger. A complex software development tool chain, for example, one used for developing a product such as a video game, can includes tools for preparing sound effects, music, textures, 3-dimensional models and animations, and for combining these resources into a finished product. The transfer/receive component 210 can transfer the downloadable client application and plugins 260 related to the UI wizards to the client computer 100 and can also receive media content and metadata bundles 280 from the client computer 100, by using, for example, a HTTPs compliant Internet connection. The storage device 250 also stores the media content and metadata bundle 280 received from the client computer 100.

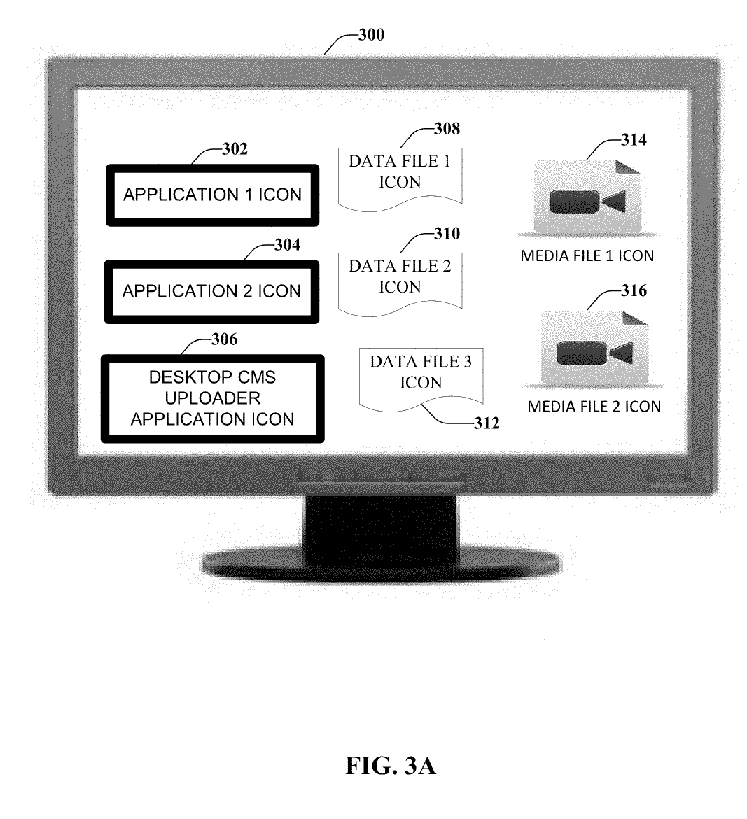

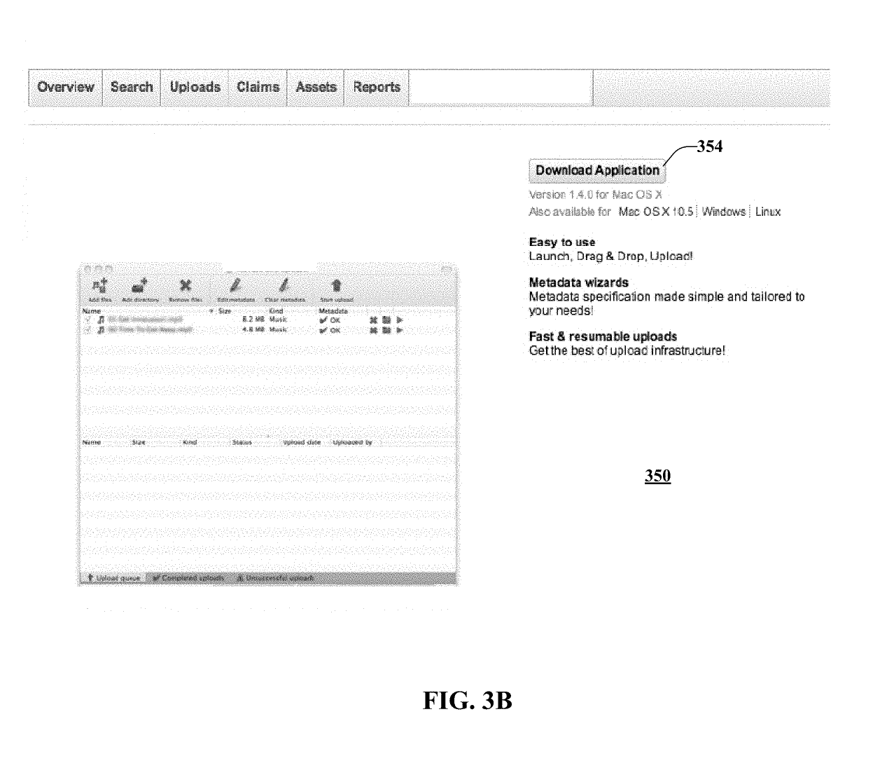

FIGS. 3, 4, 5, 6 and 7 illustrate various exemplary representations of UI wizards having graphical and user interactive interfaces.

FIG. 3A illustrates a display 300 of an exemplary client computer, according to an aspect of the subject disclosure. As shown, the desktop includes icons (or push buttons) for application 1 302, application 2 304, desktop uploader application 306, data file 1 308, data file 2 310, data file 3 312, media file 1 314 and media file 2 316. A user can select an application or file shown on the desktop by, for example, mouse clicking or double mouse clicking on the respective icon by using a mouse. For example, the user can launch the UI Wizards of the subject disclosure by selecting the desktop CMS uploader application 306. The media file 1 314 and/or media file 2 316 can include the media content that the user wants to upload to the server computer 200. The data file 1 308, data file 2 310 and/or data file 3 312 can contain the metadata associated with the media content, and these files 308, 310 and/or 312 can be used to populate the metadata fields of the UI wizards. The data files 308, 310 and 312 can include metadata related information, for example, a user's desired percentage allocation of revenues generated by advertisements embedded in his/her media content for various geographical locations. In an example, one of more data files 308, 310 and 312 can include user editable files, for example, spreadsheets or word processing files. In an example, one or more data files 308, 310 and 312 are generated by a user of the client device 100. In an example, one of more data files 308, 310 and 312 can include metadata files that were generated by the UI wizards 112 during a previous bundle generation and/or uploading. In an example, when a UI wizard 112 does not recognize formatting (e.g. file extension) of a particular data file 308, 310 or 312 from which a user desires to ingest metadata information into the UI wizard 112, the UI wizard 112 is configured to search for and obtain tools (e.g. application programs) from a network (e.g. Internet) to enable it 112 to access information embedded in the desired file 308, 310 or 312.

FIG. 3B is a screenshot of a sample user interface that provides for downloading to a client device a desktop CMS uploader application in accordance with aspects of this disclosure. In FIG. 3B, the user interface 350 is provided via a web browser. The user interface 350 includes a user selectable tool (e.g. a soft pushbutton) 354 for commencing download of the desktop CMS uploader application 306 from a website to the client computer 300.

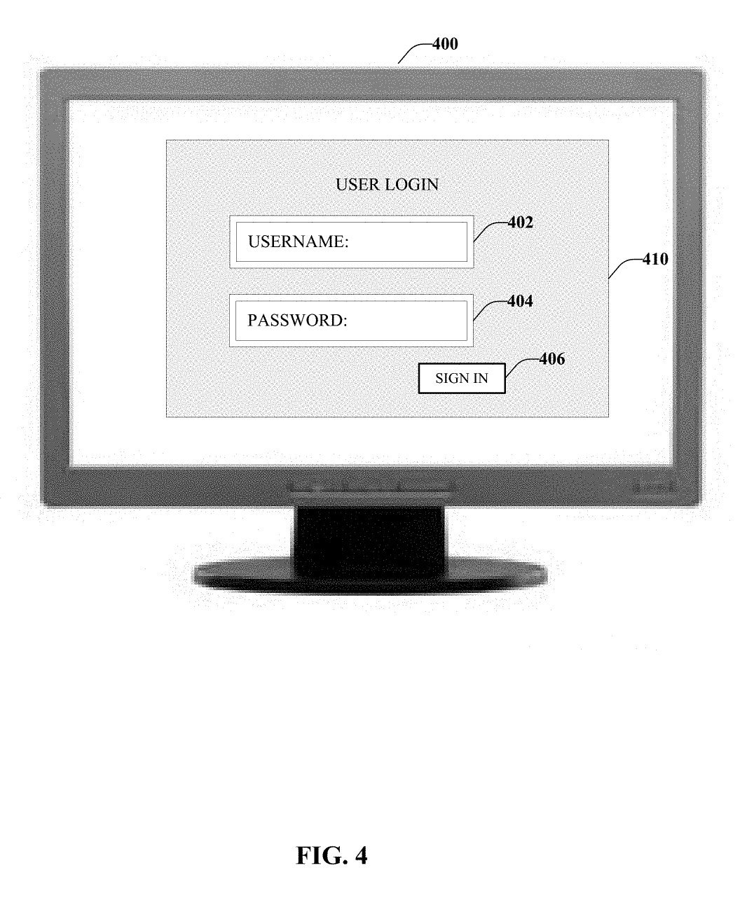

FIG. 4 illustrates a display 400 of an exemplary client computer showing a user authentication UI wizard 410, according to an aspect of the subject disclosure. The UI wizard 410 can be used for user authentication and provides a graphical interface for a user to enter a username in field 402 and a password in field 404. Upon entering a username and a password, the user can click on the push button 406 to log into the desktop uploader application 306. It is to be appreciated that the client computer 100 and the server computer 200 need not be communicably coupled for the UI wizard 410 to perform the user authentication. In other words, the user authentication can be completed entirely at the client computer 100. It is to be appreciated that the UI wizard 410 can pose more/other questions and queries to the user in addition to requesting username and password, in order to try to authenticate the user.

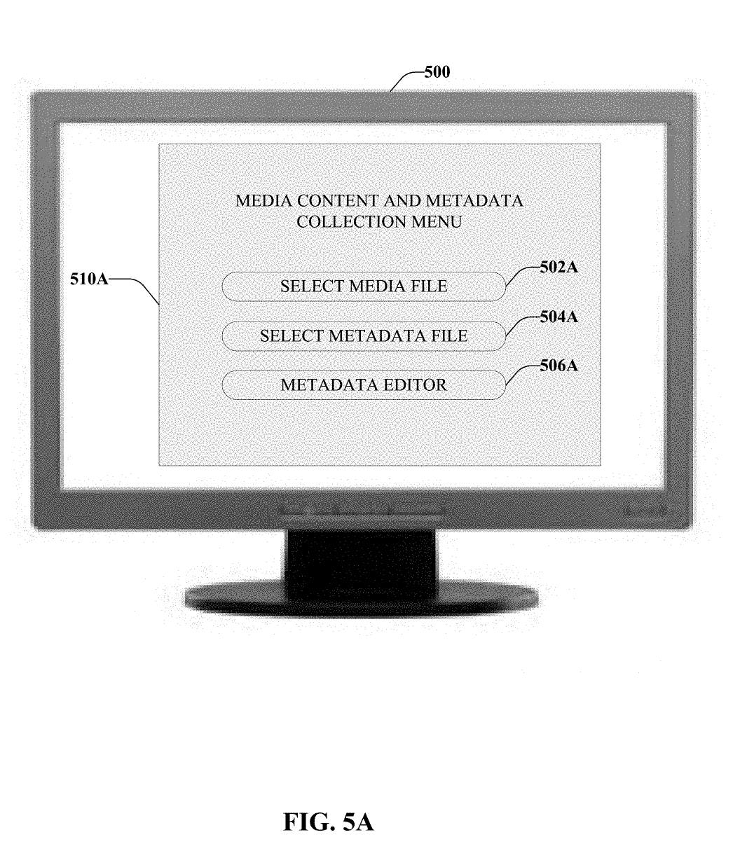

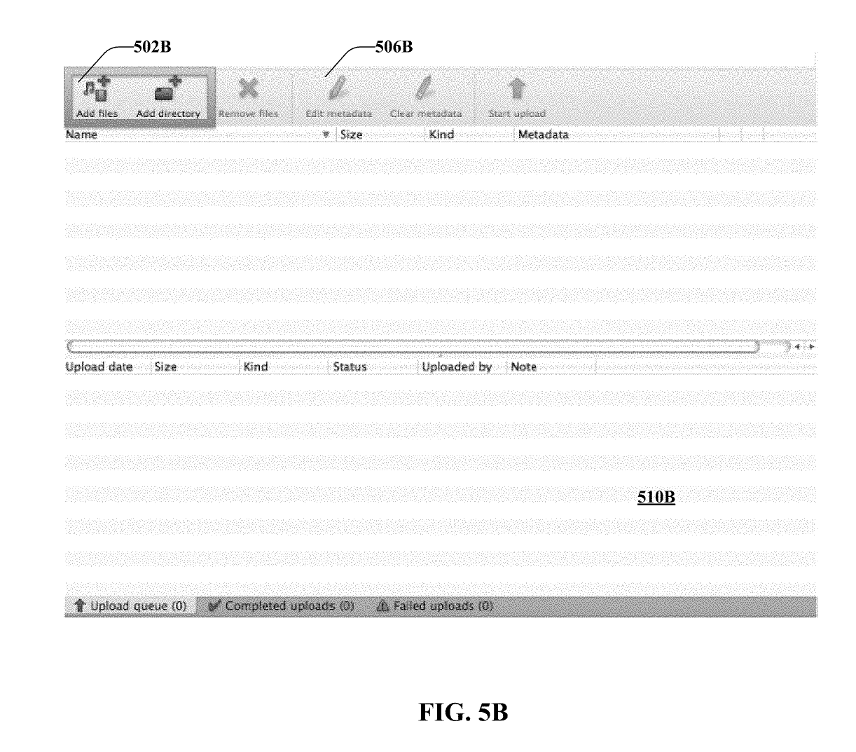

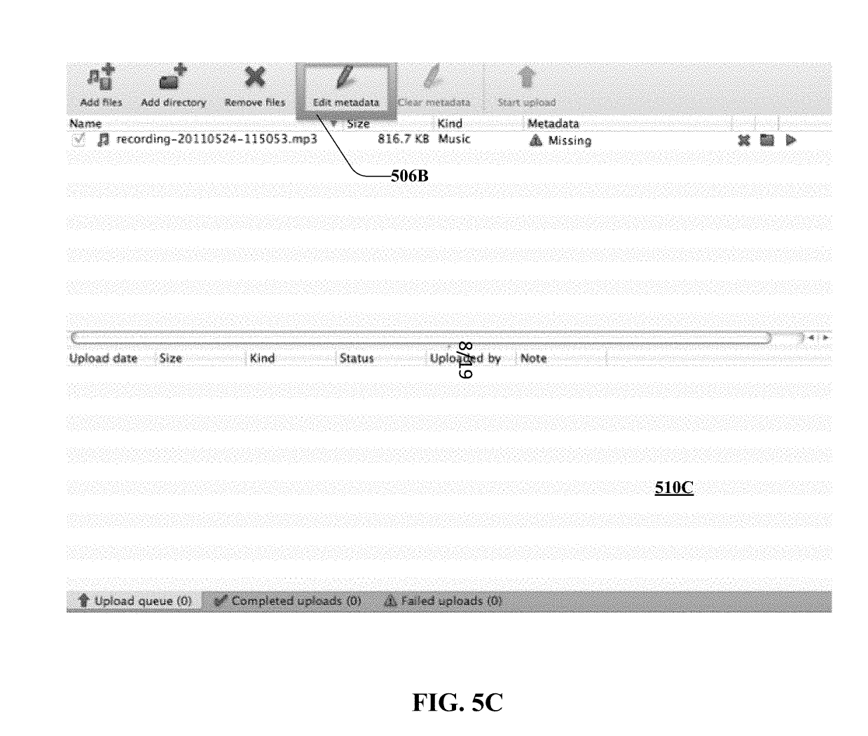

FIG. 5A illustrates a display 500 of an exemplary client computer showing menu options provided by a UI wizard 510A, according to an aspect of the subject disclosure. In an exemplary implementation, the UI wizard 510A provides the user with three push button options (or selection tools). In the subject disclosure, the terms selection tools, push buttons and soft buttons are used interchangeably and refer to a mechanism for a user to make a selection on a display by using a user input device 160, for example, a mouse, a keyboard, or touchscreen. Push button 502A allows the user to select media file(s) that the user wants to upload. Push button 504A allows the user to select the metadata file(s) that can be used to generate user profile/metadata. Push button 506A allows the user to enter metadata by way of an editor. It is to be appreciated that other push buttons can be provided in other embodiments. For example, a push button can be provided that allows the user to select the natural language (e.g. French, English) for the UI wizards' representations. Also, for example, a push button can be provided which, when selected, launches a menu (or listing) that allows the user to select an extension for file(s) that contain metadata information (e.g. ‘.xml’ or ‘.csv’).

FIG. 5B is a screenshot of a sample uploader application user interface 510B that provides for selecting files for uploading in accordance with aspects of this disclosure. In FIG. 5B, media files, such as video or music files, can be selected by selecting icon 502B. In use, after a user selects all the files the user wishes to upload, the user can select an icon 506B to edit metadata associated with the files.

FIG. 5C illustrates a screenshot of the sample uploader application user interface 510A after a user has selected all the files the user wishes to upload. As shown in FIG. 5C, the file that the user has selected is a music file, but is missing certain metadata. The user can select the icon 506B to edit metadata associated with the file.

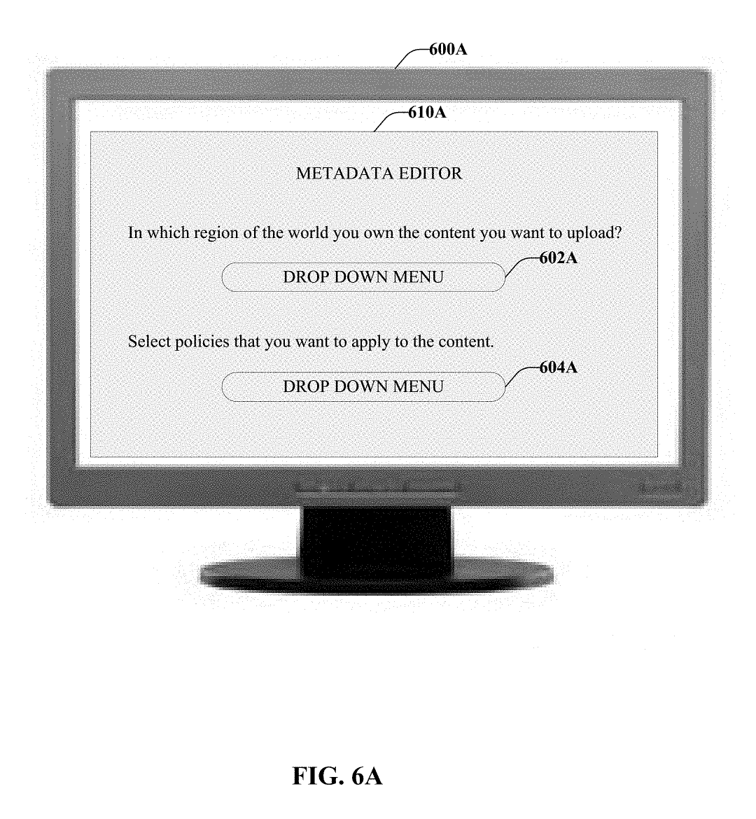

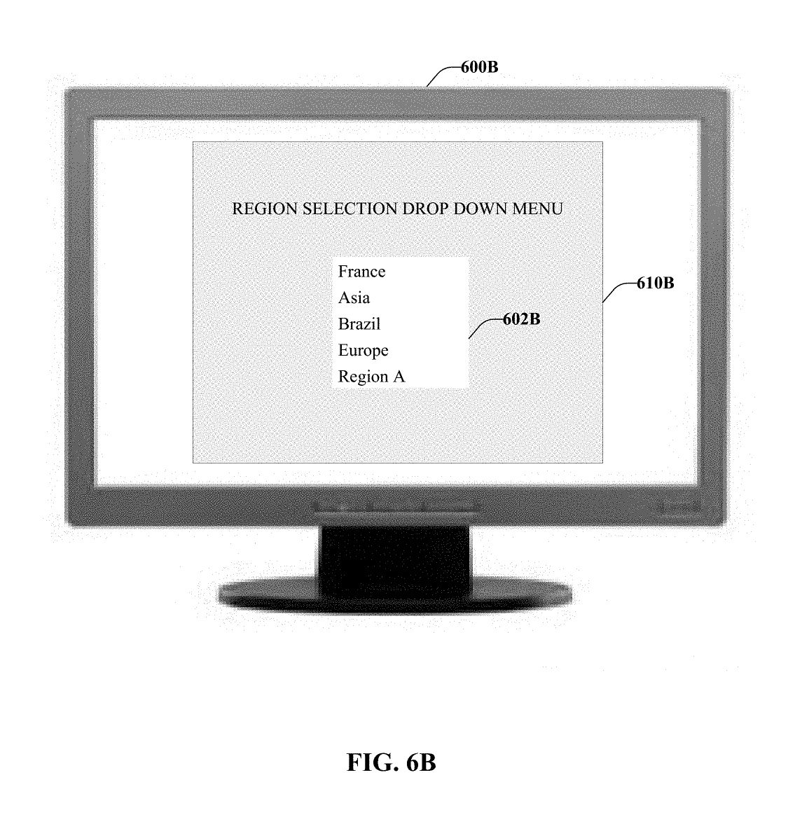

FIG. 6A illustrates a display 600A of an exemplary client computer showing a metadata editor UI wizard 610A, according to an aspect of the subject disclosure. The metadata editor 610A can be launched, for example, by selecting push button 506A or 506B shown in FIG. 5A, 5B or 5C. The metadata editor 610A provides a drop down menu 602A that allows a user to select the region(s) of the world in which the user has rights to the media content that the user wants to upload. It is to be appreciated that in other exemplary embodiments, the UI wizard 610A or a different UI wizard can query the user about the specific ownership rights possessed by the user, for example, whether the user has performance rights, mechanical rights and/or synchronous rights to the media content in a specific geographical region. The metadata editor 610A also provides a drop down menu 604A that allows the user to select the representations of policies that the user wants to apply to the content. For example, the user may want to charge a specific fee for viewing of the content in a specific geographical region. Also, for example, the user may want to specify a revenue sharing formula for sharing revenues with advertisers in a specific geographical region. Also, for example, the user may want to request periodic feedback about the number of viewers of the content. It is to be appreciated that the UI wizards 112, 114 and 116 are representation agnostic to the user and the implementation of the policies is performed by the server computer 200. Also, in one implementation, if the user enters invalid or irrelevant data, the UI wizard 610A is configured to provide an error message stating, for example, “You have entered invalid metadata.”

FIG. 6B illustrates a display 600B of an exemplary client computer showing a drop down menu provided by a UI wizard 610B, according to an aspect of the subject disclosure. The UI wizard 610B can be launched, for example, by pressing/selecting push button 602A in FIG. 6B. The drop down menu 602B provides a list of countries, continents and geographical regions for selection. The user can also customize regions for selection. For example, Region A can include Italy, France, New York City, London and Eastern Europe. According to an aspect of the subject disclosure, the drop down menu allows the user to create one or more customized regions that are of interest to the user, and so the user need not select countries, cities and regions of interest individually, e.g. one at a time, while preparing content and its associated metadata for uploading.

According to an aspect of the subject disclosure, in an example, the UI wizards (e.g. 116) provide a push button that starts the upload. In an implementation, the uploading is commenced upon selection (e.g. by a mouse click or voice command) of the upload push button by a user. In other words, in an implementation, uploading doesn't automatically begin upon formation of a bundle. In an implementation, a user must both select the upload push button and provide authentication information (e.g. username and password) to cause the UI wizard 116 to commence the uploading. The UI wizards can contain indicators that provide information about the upload queue, completed uploads and failed uploads. In one embodiment of the subject disclosure, the network connection between the client computer 100 and the server computer 200 is automatically established upon selection of the upload push button. In another embodiment of the subject disclosure, the user must establish a network connection between the client computer 100 and the server computer 200 prior to selecting the upload push button.

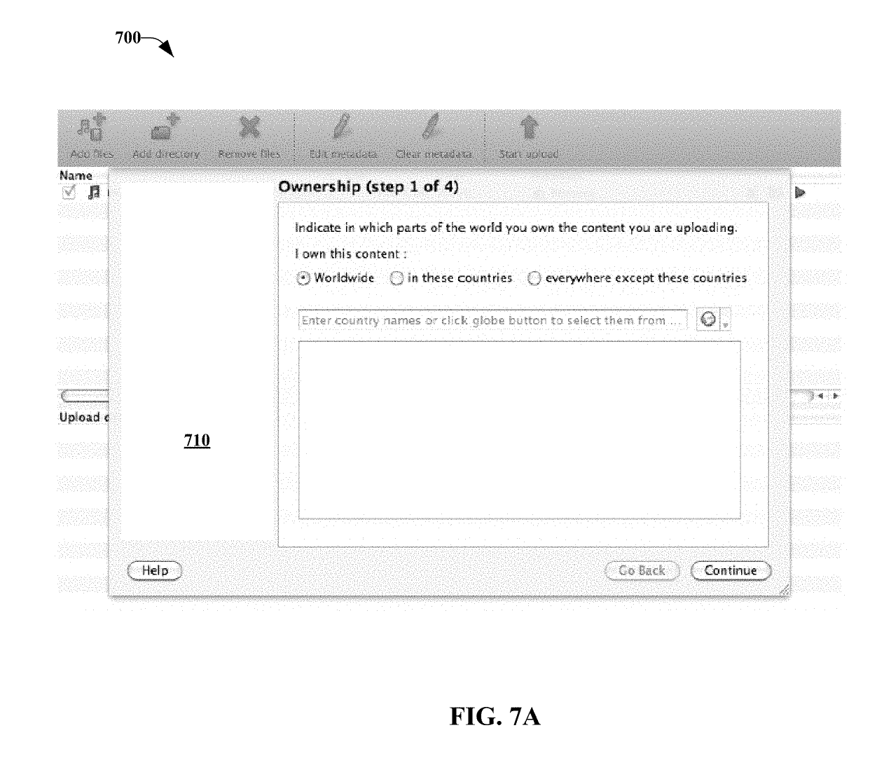

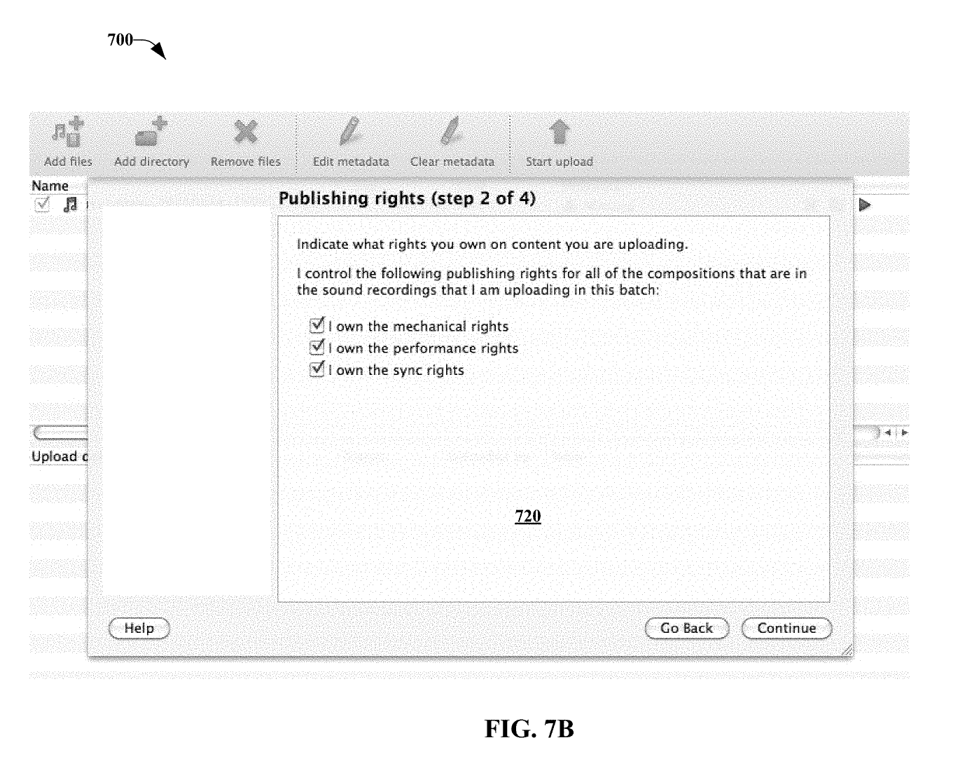

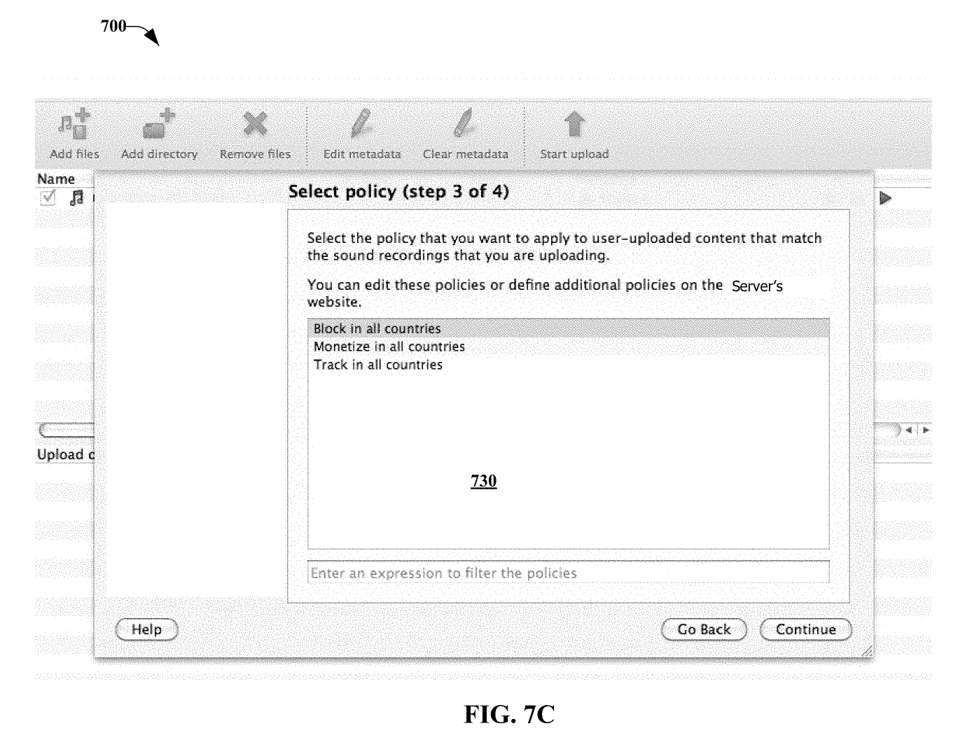

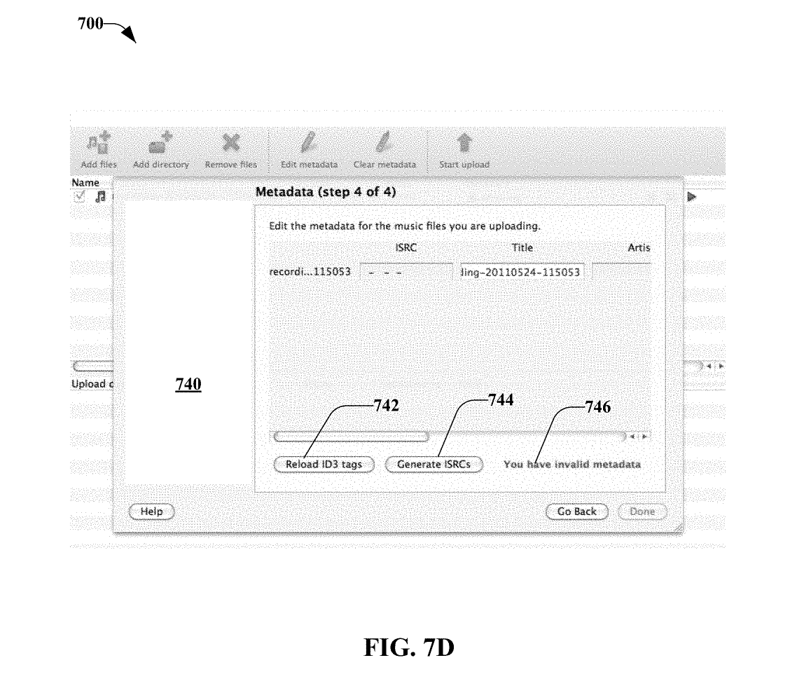

FIGS. 7A-7D depict a multi-step UI wizard. Specifically, FIGS. 7A-7D show sample screenshots of a UI wizard 700 displayed in response to the user selecting to edit metadata, e.g., by selecting icon 506B shown in FIG. 5C. The multiple step wizard can gather information relating to, for example, ownership, rights, policies, and additional metadata relevant to the particular type of file. For example, when the type of file is music, the additional metadata can include ISRC, title, artist, genre, release date, recording label, etc.

FIG. 7A illustrates a screenshot of a first component 710 of the UI wizard 700 in accordance with an aspect of this disclosure. The first component 710 requests information relating to the scope of geography based ownership of the media content that the user of the client device 100 desires to upload to the CMS (e.g. 200).

FIG. 7B illustrates a screenshot of a second component 720 of the UI wizard 700 in accordance with an aspect of this disclosure. The second component 720 requests detailed information relating to the nature and extent of the rights that the user possesses in the media content, such as the user's rights to publish the media content that will be uploaded. The term user as used herein refers to the user of the client device 100, the creator of the media content and/or the owner or distributor of the media content.

FIG. 7C illustrates a screenshot of a third component 730 of the UI wizard 700 in accordance with an aspect of this disclosure. The third component 730 provides a mechanism for the user to indicate policies, such as monetization policies, to associate with the media content that will be uploaded.

FIG. 7D illustrates a screenshot of a fourth component 740 of the UI wizard 700 in accordance with an aspect of this disclosure. The fourth component 740 provides a mechanism for the user to add and edit additional metadata for the content that will be uploaded. In one aspect, data for such metadata fields can be pre-populated, such as by accessing metadata contained in the selected file(s) such as ID3 tags or ISRC codes. The push button tools ‘Reload ID3 tags’ 742 and ‘Generate ISRCs’ 744 allow the user to add metadata from ID3 tags and ISRC codes respectively. According to an aspect of the subject disclosure, if a user provides a metadata file type that is not compatible with the UI wizard 700 or provides an incorrect ISRC code, the UI wizard 700 displays a warning 746 to alert the user that the user has entered invalid metadata information.

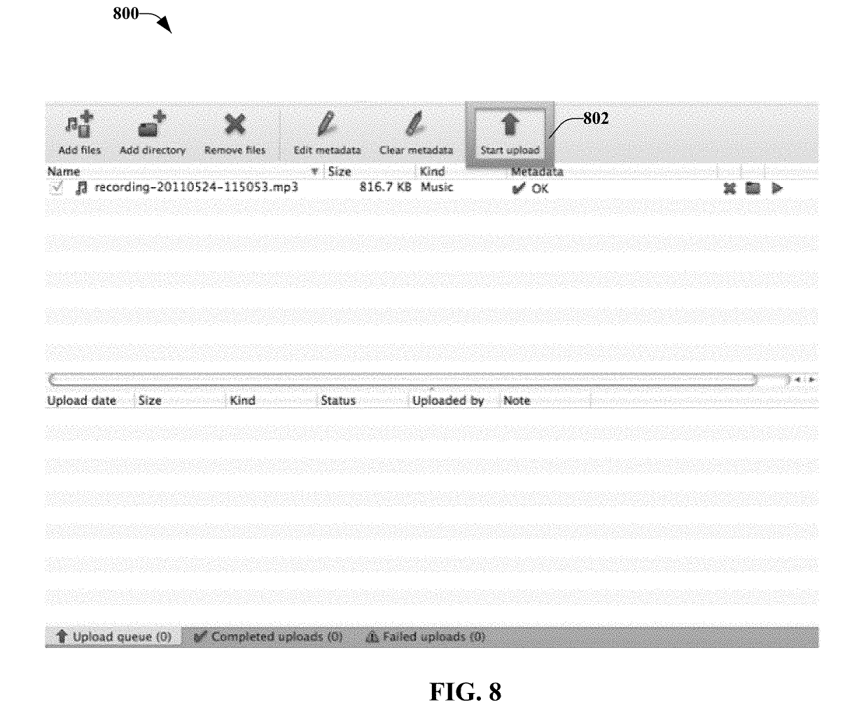

FIG. 8 illustrates a screenshot of the sample uploader application user interface wizard 800 that is displayed to the user after the bundling of the media content and metadata has been completed, in accordance with an aspect of this disclosure. A start upload icon 802 is provided that enables a user to selectively begin the process of uploading the selected file(s) with the associated metadata. In an implementation, additional icons are provided that allow the user to cancel, pause or restart the uploading process. In an implementation, the UI wizard 800 displays an indicator tool that allows the user to monitor the progress of the upload. For example, the indicator can progressively update the percentage of the upload that has been completed.

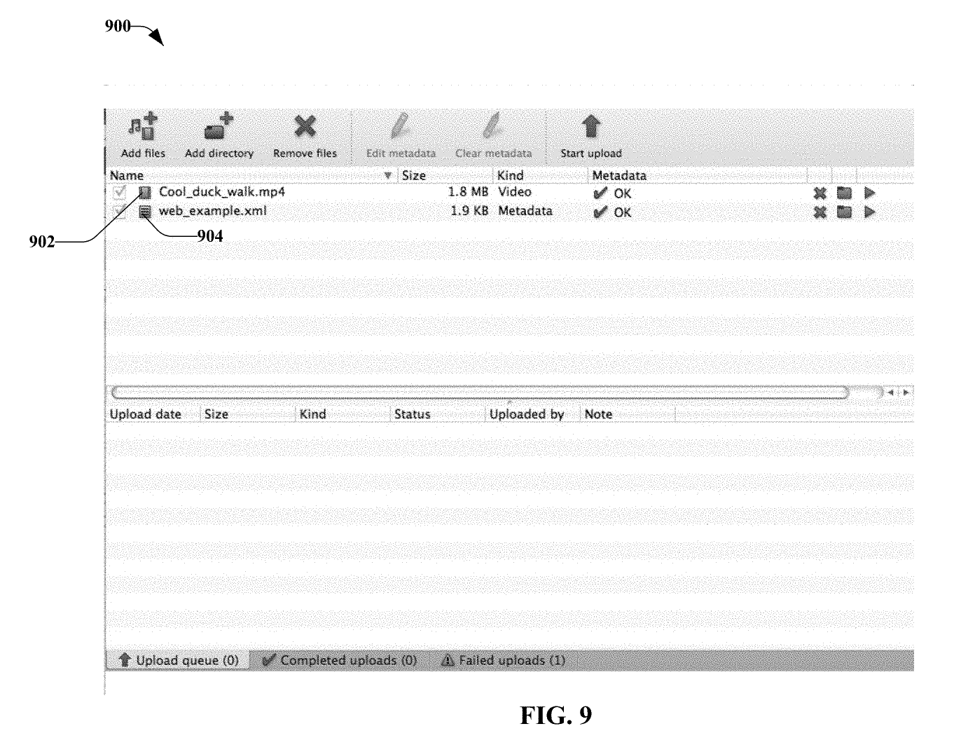

FIG. 9 illustrates a screenshot of the sample uploader application user interface wizard 900 that is displayed to the user after the user has selected files to upload. In FIG. 9, the user has selected a video file 902 along with an associated metadata file 904. The metadata file 904 can correspond to, for example, data file 1 308.

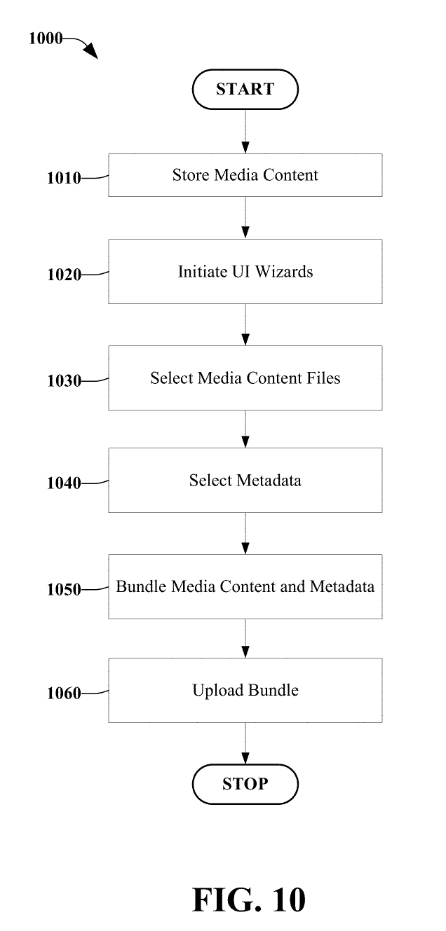

FIG. 10 illustrates an exemplary flow diagram 1000 of a methodology in which a set of UI wizards are used to prepare media content and metadata for uploading to a content management system (CMS), according to an aspect of the subject disclosure. At 1010, media content file(s) including music, video, artwork, or other creative work are stored in a memory location (e.g. 140, 150) of a client computer (e.g. 100). The client computer can include a personal computer of a creator or distributor of content. At 1020, the UI wizards (e.g. 112, 114 and 116) are initiated by a user, for example, by mouse clicking on an application program file for UI wizards (e.g. 306). In one implementation, upon initialization, the UI wizards authenticate the user as being in a group of users that is allowed to upload media content to the server computer (e.g. 200) and/or as a user that may have metadata information about the media content. The UI wizards can authenticate the user by prompting the user to enter his/her authentication information, for example, username and password.

At 1030, media content files that the user desires to upload, distribute and/or monetize are selected, for example, by dragging and dropping them in a UI wizard box. At 1040, metadata associated with the media content is identified. The UI wizards contain numerous interactive wizards (or interactive user interfaces) for gathering information from a user of the client computer, for example, by prompting the user to provide information and providing the user with selectable (e.g. by way of soft screen buttons) menu choices. In addition to obtaining information manually entered by a user by way of input devices, the UI wizards also use ID3 tags, cloud memory and client computer memory to populate metadata fields. In an example implementation, the UI wizards initially populate (or pre-fill) the metadata fields by using metadata that was generated during a previous instance of media content upload, and prompt the user to edit (or update) the populated metadata fields. For example, the user can update the title of the media content or update his/her monetization policy for a particular geographical region with respect to this particular media content. According to an aspect of the present invention, the user of the client computer has the option of not providing certain information requested by the UI wizards. Moreover, in an implementation of the subject disclosure, the UI wizards can obtain standardized metadata (e.g. based on regulations for monetization or distribution or subject matter classification in a particular geographical region) from the server computer). At 1050, the media content and metadata are bundled. At 1060, the bundle is uploaded to a server computer by way of a network connection. According to an aspect of the subject disclosure, the network connection need not be activated (or enabled) until after the bundling (at 1050) is completed.

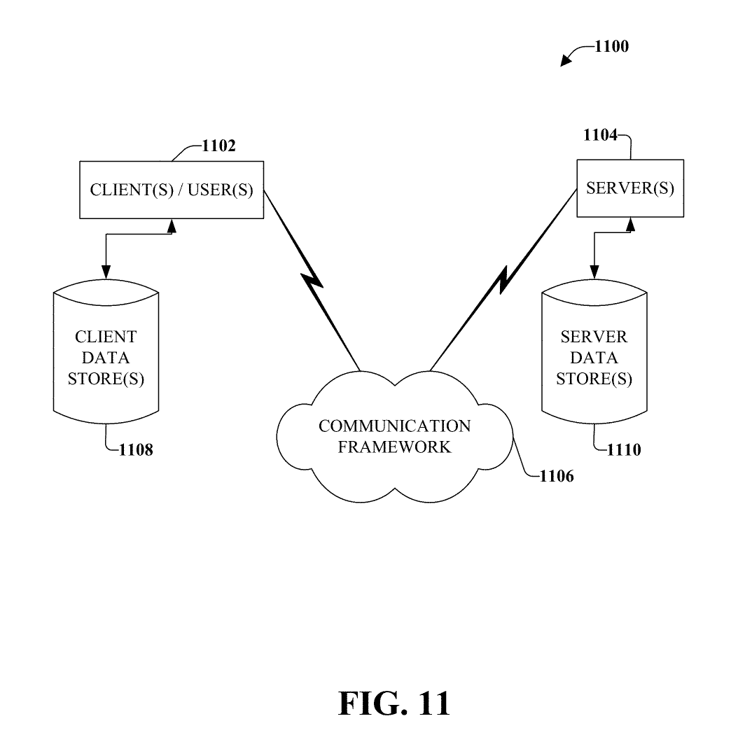

Referring now to FIG. 11, there is illustrated a schematic block diagram of a computing environment 1100, in accordance with the subject specification. The system 1100 includes one or more client(s) 1102, which can include an application or a system that accesses a service on the server 1104. The client(s) 1102 can be hardware and/or software (e.g., threads, processes, computing devices). The client(s) 1102 can house cookie(s), metadata, and/or associated contextual information by employing the specification, for example. The client(s) 1102 can represent the client computer 100.

The system 1100 also includes one or more server(s) 1104. The server(s) 1104 can also be hardware or hardware in combination with software (e.g., threads, processes, computing devices). The servers 1104 can house threads to perform, for example, sending a video manifest, monitoring client capabilities, etc. in accordance with the subject disclosure. One possible communication between a client 1102 and a server 1104 can be in the form of a data packet adapted to be transmitted between two or more computer processes where the data packet contains, for example, portions of the media content or metadata stream(s). The data packet can include a cookie and/or associated contextual information, for example. The system 1100 includes a communication framework 1106 (e.g., a global communication network such as the Internet) that can be employed to facilitate communications between the client(s) 1102 and the server(s) 1104. The server(s) 1104 can represent the server computer 200.

Communications can be facilitated via a wired (including optical fiber) and/or wireless technology. The client(s) 1102 and server(s) 1104 can be located in different countries of the world. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

The server(s) 1104 can include server(s) of a service provider that publishes/distributes media content to its subscribers. The client(s) 1102 can include computers of individual content providers or professional distributors. According to an aspect of the subject disclosure, the UI wizards provide scalable technology because they can be used by either individual content creators or large distribution houses. Thus, the service provider can partner with any client regardless of the size, location or technology sophistication level of the client partner. According to an aspect of the subject disclosure, the server 1104 provides only certain UI wizards to a particular partner and masks others, depending on the requirements of the particular partner.

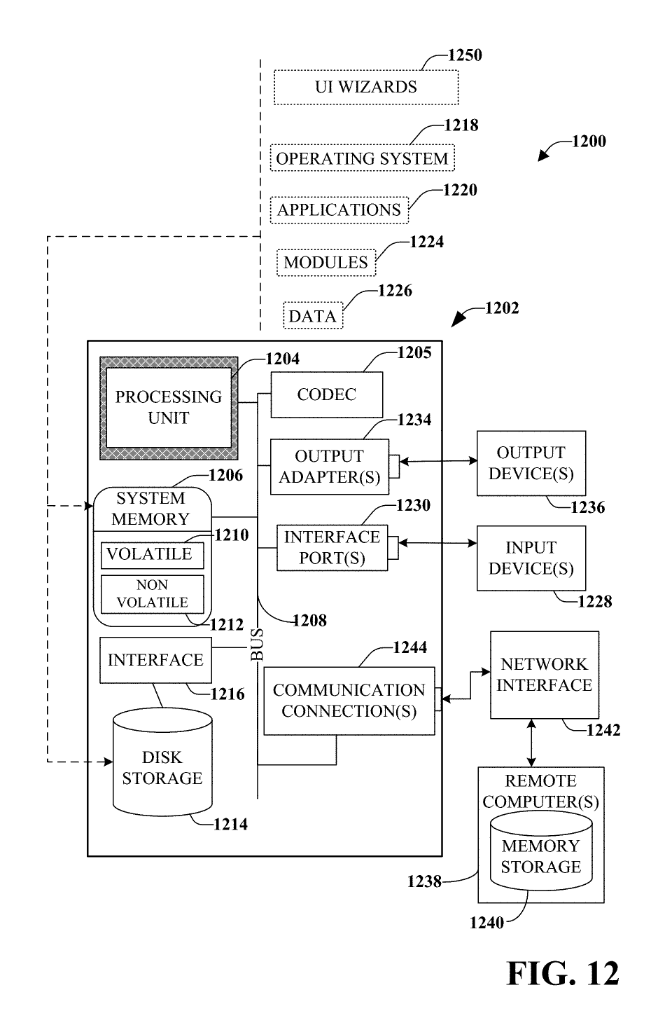

FIG. 12 is an illustration of a schematic diagram of an exemplary networked or distributed computing environment 1200, in which various aspects of the client computer 100 or the server computer 200 can be implemented. A computer 1202 includes a processing unit 1204, a system memory 1206, a codec 1205, and a system bus 1208. The codec 1205 is a device or computer program capable of encoding or decoding a digital data stream or signal. The codec 1205 encodes a data stream or signal for transmission, storage or encryption, or decodes it for playback or editing. The codec 1205 can be used in videoconferencing, streaming media and video editing applications. The computer 1202, which can represent the client computer 100 or the server computer 200, can include a desktop or a laptop computer or a handheld computer such as a smart phone or tablet computer. The system bus 1208 is used to couple system components including, but not limited to, the system memory 1206 to the processing unit 1204. The processing unit 1004 can be any of various available processors. Dual microprocessors and other multiprocessor architectures also can be employed as the processing unit 1204.

The system bus 1208 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1206 includes volatile memory 1210 and non-volatile memory 1212. The basic input/output system (BIOS), containing the basic routines to transfer information between elements within the computer 1202, such as during start-up, is stored in non-volatile memory 1212. By way of illustration, and not limitation, non-volatile memory 1212 can include read only memory (ROM), programmable ROM (PROM), electrically programmable ROM (EPROM), electrically erasable programmable ROM (EEPROM), or flash memory. Volatile memory 1210 includes random access memory (RAM), which acts as external cache memory. According to present aspects, the volatile memory may store the write operation retry logic and the like. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM).

Computer 1202 may also include removable/non-removable, volatile/non-volatile computer storage media. FIG. 12 illustrates, for example, a disk storage 1214. Disk storage 1214 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1214 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1214 to the system bus 1008, a removable or non-removable interface is typically used, such as interface 1216.

It is to be appreciated that FIG. 12 describes software that acts as an intermediary between users and the basic computer resources described in the suitable operating environment 1200. Such software includes an operating system 1218. Operating system 1218, which can be stored on disk storage 1214, acts to control and allocate resources of the computer system 1202. Applications 1220 take advantage of the management of resources by operating system 1218 through program modules 1224, and program data 1226, such as the boot/shutdown transaction table and the like, stored either in system memory 1206 or on disk storage 1214. According to an aspect of the subject disclosure, an application program includes the UI wizards 1250. The UI wizards 1250 can include both an application program and associated plug-ins that can be selectively added and removed from the application program. It is to be appreciated that the claimed subject matter can be implemented with various operating systems or combinations of operating systems.

A user enters commands or information into the computer 1202 through input device(s) 1228. Input devices 1228 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1204 through the system bus 1208 via interface port(s) 1230. Interface port(s) 1230 include, for example, a serial port, a parallel port, a game port, and a universal serial bus (USB). Output device(s) 1236 use some of the same type of ports as input device(s) 1228. Thus, for example, a USB port may be used to provide input to computer 1202 and to output information from computer 1202 to an output device 1236. Output adapter 1234 is provided to illustrate that there are some output devices 1236 like monitors, speakers, and printers, among other output devices 1236, which benefit from special adapters. The output adapters 1234 include, by way of illustration and not limitation, video and sound cards that provide a means of connection between the output device 1236 and the system bus 1208. It should be noted that other devices and/or systems of devices provide both input and output capabilities such as remote computer(s) 1238.

Computer 1202 can operate in a networked environment using logical connections to one or more remote computers, such as remote computer(s) 1238. The remote computer(s) 1238 can be a personal computer, a server, a router, a network PC, a workstation, a microprocessor based appliance, a peer device, a smart phone, a tablet, or other network node, and typically includes many of the elements described relative to computer 1202. For purposes of brevity, only a memory storage device 1240 is illustrated with remote computer(s) 1238. Remote computer(s) 1238 is logically connected to computer 1202 through a network interface 1242 and then connected via communication connection(s) 1244. Network interface 1242 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1244 refers to the hardware/software employed to connect the network interface 1242 to the bus 1208. While communication connection 1244 is shown for illustrative clarity inside computer 1202, it can also be external to computer 1202. The hardware/software necessary for connection to the network interface 1242 includes, for exemplary purposes only, internal and external technologies such as, modems including regular telephone grade modems, cable modems and DSL modems, ISDN adapters, and wired and wireless Ethernet cards, hubs, and routers.

The illustrated aspects of the disclosure may also be practiced in distributed computing environments where certain tasks are performed by remote processing devices that are linked through a communications network. In a distributed computing environment, program modules can be located in both local and remote memory storage devices. Moreover, the systems and processes described herein can be embodied within hardware, such as a single integrated circuit (IC) chip, multiple ICs, an application specific integrated circuit (ASIC), or the like. Further, the order in which some or all of the process blocks appear in each process, for example in FIG. 8 should not be deemed limiting. Rather, it should be understood that some of the process blocks can be executed in a variety of orders that are not all of which may be explicitly illustrated herein.

What has been described above includes examples of the implementations of the subject disclosure. It is, of course, not possible to describe every conceivable combination of components or methodologies for purposes of describing the claimed subject matter, but many further combinations and permutations of the subject innovation are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

As used in this subject disclosure, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification can, but are not necessarily, referring to the same implementation, depending on the circumstances. Furthermore, the particular features, structures, or characteristics may be combined in any suitable manner in one or more implementations.

What is claimed is:

1. A system, comprising:
a client computer including a non-transitory memory device and a processor coupled to the non-transitory memory device to:
receive a user selection of a first user interface (UI) wizard of a plurality of UI wizards, wherein each of the plurality of UI wizards is associated with a corresponding type of media format;
interactively gather media content for uploading, wherein the media content is stored in a file;
pre-populate, by the processor, metadata fields in a UI of the first UI wizard with metadata based on the media content stored in the file;
update the metadata in the metadata fields responsive to receiving user updates;
determine whether a first type of media format of the file matches a second type of media format corresponding to a plurality of types of media format compatible with the first UI wizard;
provide a user alert responsive to the first type of media format not matching the second type of media format;
upon determining that the first type of media matches the second type of media, bundle the media content and the updated metadata to generate bundled media content, wherein the updated metadata comprises information indicative of a policy or rule for distribution of the media content; and
upload the bundled media content by way of a network link to a content hosting server computer for distribution of the media content according to the policy or rule.

2. The system of claim 1, wherein the network includes a Hypertext

3. The system of claim 1, wherein the first UI wizard and the bundled media content are compatible with one or more tool chains used by the content hosting server computer.

4. The system of claim 1, wherein the processor is further to:
display at least a portion of the metadata fields in the UI subsequent to pre-populating the metadata fields; and
mask one or more of the metadata fields in the UI that are not relevant to at least one of a user of the client computer or the media content.

5. The system of claim 1, wherein the processor is to retrieve the policy or rule from remote storage.

6. (canceled)

7. The system of claim 1, wherein the processor is to extract at least a portion of the metadata by using one of an ID3 tag or an International Standard Recording Code (ISRC).

8. The system of claim 1, wherein the first UI wizard is representation agnostic.

9. The system of claim 1, wherein the processor is to provide resumable uploading of the bundled media content from a point of upload interruption.

10-11. (canceled)

12. A method, comprising:
receiving a user selection of a first user interface (UI) wizard of a plurality of UI wizards, wherein each of the plurality of UI wizards is associated with a corresponding type of media format;
gathering media content stored in a file;
pre-populating, by a processor, metadata fields in a UI of the first UI wizard with metadata based on the media content stored in the file;
updating the metadata in the metadata fields responsive to receiving user updates;
determining whether a first type of media format of the file matches a second type of media format corresponding to a plurality of types of media format compatible with the first UI wizard;
providing a user alert responsive to the first type of media format not matching the second type of media format;
upon determining that the first type of media format matches the second type of media format, bundling the media content and the updated metadata to generate bundled media content, wherein the updated metadata comprises information indicative of a policy or rule for distribution of the media content; and
uploading the bundled media content to a remote computer for distribution of the media content according to the policy or rule.

13. The method of claim 12, wherein the gathering of the media content and the updating of the metadata is by prompting a user to enter information by using a user friendly interface editor.

14. (canceled)

15. The method of claim 12, wherein the pre-populating of one or more of the metadata fields is by extracting information from one of an ID3 tag or an International Standard Recording Code (ISRC).

16. The method of claim 12, wherein the pre-populating of one or more of the metadata fields is by extracting information from a data file, wherein the data file is created by a user of a client computer that comprises the processor and hosts the first UI wizard.

17. The method of claim 12, wherein the pre-populating of one or more of the metadata fields is by extracting information from a metadata file that was previously generated by the processor for different media content.

18. A client computer, comprising:
a network interface for communicating with a server computer;
a non-transitory memory device; and
a processor coupled to the non-transitory memory device to:
receive a user selection of a first user interface (UI) wizard of a plurality of UI wizards, wherein each of the plurality of UI wizards is associated with a corresponding type of media format;
interactively gather media content stored in a file;
pre-populate, by the processor, metadata fields in a UI of the first UI wizard with metadata based on the media content stored in the file;
update the metadata in the metadata fields responsive to receiving user updates;
determine a first type of media format of the file matches a second type of media format corresponding to a plurality of file types of media format compatible with the first UI wizard;
provide a user alert responsive to the first type of media format not matching the second type of media format;
upon determining that the first type of media format matches the second type of media format, bundle the media content and the updated metadata to generate bundled media content, wherein the updated metadata comprises information indicative of a policy or rule for distribution of the media content; and
upload the bundled media content to the server computer for distribution of the media content according to the policy or rule.

19. The client computer of claim 18, wherein the first UI wizard and the bundled media content are compatible with one or more tool chains used by the server computer.

20. The client computer of claim 18, wherein the first UI wizard is representation agnostic.

21. The system of claim 1, wherein the processor is to provide the user alert in response to the second type of media format associated with the first UI wizard being a video file and the first type of media format of the file being an audio file.

22. The system of claim 1, wherein the processor is to bundle the media content and the metadata in response to the second type of media format associated with the first UI wizard being a first video file and the first type of media format of the file being a second video file.

23. The method of claim 12, wherein the uploading comprises resumable uploading from a point of uploading interruption.

24. The client computer of claim 18, wherein the bundled media content is compatible with a tool chain of the server computer.
